(19) United States
(12) Patent Application Publication
(10) Pub. No.: US 2017/0178341 A1
(43) Pub. Date: Jun. 22, 2017

(54) Single Parameter Segmentation of Images

(71) Applicant: UTI Limited Partnership, Calgary (CA)

(72) Inventors: Naser Mahmoud El-Sheimy, Calgary (CA); Adel Moussa, Calgary (CA)

(73) Assignee: UTI Limited Partnership, Calgary (CA)

(21) Appl. No.: 15/387,328

(22) Filed: Dec. 21, 2016

Related U.S. Application Data
(60) Provisional application No. 62/270,394, filed on Dec. 21, 2015.

(51) Int. Cl. G06T 7/136; G06T 7/187; G06T 7/90; G06T 5/00; G06T 7/12

(52) U.S. Cl. CPC G06T 7/136; G06T 5/002; G06T 7/12; G06T 7/90; G06T 7/187; G06T 2207/30181; G06T 2207/10024

(57) ABSTRACT

Embodiments of methods and systems for single parameter segmentation of images are presented. In an embodiment, a method includes assigning a first label to a first pixel in an image. The method may also include measuring a characteristic of a first pixel. Additionally, the method may include measuring the characteristic of a second pixel, the second pixel being adjacent to the first pixel in the image. Also, the method may include assigning the first label to the second pixel in response to a determination that the characteristic of the second pixel has a measured value above a similarity threshold value. The method may further include assigning a second label to the second pixel in response to a determination that the measured value of the characteristic of the second pixel is below the similarity threshold value.

### FIELD

This disclosure relates generally to image processing, and more specifically, to single parameter segmentation of images.

### BACKGROUND

In the last decade, Object Based Image Analysis (OBIA) has been employed broadly in various mapping applications. Dealing with image objects in OBIA can circumvent many of the shortcomings associated with pixel based analysis. Image segmentation is one step for OBIA, where the image is to be divided into segments or logical objects based on homogeneity or similarity measures. These extracted objects serve as semantic and descriptive targets for the further analysis steps. As such, adoption of image segmentation methodology can improve the analysis results significantly. Various theories and assumptions have been utilized to develop image segmentation techniques that serve a wide variety of applications.

The improper selection of the segmentation parameters can lead to either over-segmented or under-segmented images. Over-segmentation occurs when the same object in the image is segmented into many segments despite the high homogeneity between its pixels. FIG. 1 illustrates a sample of over segmented image, where homogenous areas such as the building roofs and the road are segmented into many segments despite its homogeneity. Under-segmentation occurs when the different objects in the image are segmented into one segment despite the high heterogeneity between its pixels. FIG. 2 depicts a sample of under segmented image, where heterogeneous areas such as the two segments with first and second boundaries are segmented into single segments despite its heterogeneity. The segment with the second boundary includes vegetation and building roofs of different colors.

### SUMMARY

Embodiments of methods and systems for single parameter segmentation of images are presented. In an embodiment, a method includes assigning a first label to a first pixel in an image. The method may also include measuring a characteristic of a first pixel. Additionally, the method may include measuring the characteristic of a second pixel, the second pixel being adjacent to the first pixel in the image. Also, the method may include assigning the first label to the second pixel in response to a determination that the characteristic of the second pixel has a measured value above a similarity threshold value. The method may further include assigning a second label to the second pixel in response to a determination that the measured value of the characteristic of the second pixel is below the similarity threshold value.

An embodiment of a system may include a data storage device configured to store an image file, the image comprising a plurality of pixels. Additionally, the system may include a data processor coupled to the data storage device. In an embodiment, the data processor may be configured to assign a first label to a first pixel in an image. measure a characteristic of a first pixel, measure the characteristic of a second pixel, the second pixel being adjacent to the first pixel in the image, assign the first label to the second pixel in response to a determination that the characteristic of the second pixel has a measured value above a similarity threshold value, and assign a second label to the second pixel in response to a determination that the measured value of the characteristic of the second pixel is below the similarity threshold value. In a further embodiment, the data processor may be configured to repeat the steps of described above for each pixel in the image.

In an embodiment, the data processor may be configured to measure a characteristic of a plurality of pixels adjacent to each pixel in the image, and assign pixels having measured values of the characteristic over the similarity threshold to a common label. Additionally, the data processor may assign a lowest available label to each pixel in the image, wherein an available label is a label of one of the adjacent pixels in the image. Also, the data processor may determine whether any of the plurality of adjacent pixels have measured values of the characteristic above the similarity threshold, and marking the larger label of the two for replacement. In such an embodiment, the data processor may iteratively replace the marked labels. In an embodiment, the data processor may measure a characteristic of a plurality of pixels adjacent to each pixel in the image, and assigning pixels having measured values of the characteristic below the similarity threshold a different label.

In a further embodiment, the data processor may pre-process the image to smooth noise while keeping the transitions between features in the image. In an embodiment, the measured characteristic comprises a boosted gradient of the image. The system may also merge groups of pixels having a common label, where at least one of the groups has a number of pixels below a threshold pixel count value.

In an embodiment, the system may segment a color image. In an embodiment, segmenting the color image may include measuring the characteristic of a plurality of neighboring pixels adjacent the first pixel, the adjacent pixels being oriented into vertical columns and horizontal rows, calculating differences in the values of the characteristic between pixels arranged in the horizontal row, calculating differences in values of the characteristic between pixels arranged in the vertical column, and identifying a smallest difference in the value of the characteristic of any of the neighboring pixels. In such an embodiment, the system may compute an accumulative histogram of the differences at each pixel in the image. Additionally, the system may compute an edge pixel ratio in response to a smallest expected segment size. Also, the system may compute a similarity threshold in response to the difference value corresponding to the computed edge pixel ratio using the computed accumulative histogram.

In an embodiment, the system may segment multi-layer image data. In one embodiment, segmenting multi-layer image data may include for pixels in a first layer: measuring the characteristic of a plurality of neighboring pixels adjacent a first pixel in the first layer, the adjacent pixels being oriented into columns and rows, calculating differences in the values of the characteristic between pixels arranged in the row, calculating differences in values of the characteristic between pixels arranged in the column, identifying a smallest difference in the value of the characteristic of any of the neighboring pixels, and for pixels in a second layer: measuring the characteristic of a plurality of neighboring pixels adjacent a first pixel in the second layer, the adjacent pixels being oriented into columns and rows, calculating differences in the values of the characteristic between pixels arranged in the row, calculating differences in values of the characteristic between pixels arranged in the column, identifying a smallest difference in the value of the characteristic of any of the neighboring pixels.

The system may be further configured to compute an accumulative histogram of the differences at each pixel for each layer. Also, the system may compute an edge pixel ratio in response to a smallest expected segment size for each layer. In such an embodiment, the system may compute the pixel potential for each pixel of each layer, limit the pixel potential value such that the value does not exceed the number of available layers, compute the aggregated potential image as a weighted sum of the pixel potential values in each layer, and compute an accumulative histogram of differences of all image pixels of the aggregated potential image. The system may also be configured to compute a similarity threshold in response to the difference value corresponding to the computed edge pixel ratio using the computed accumulative histogram.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 illustrates an example of over-segmented aerial image.

FIG. 2 illustrates an example of under-segmented aerial image.

FIG. 3 is a flowchart diagram illustrating one embodiment of a method for region growing.

FIG. 4 illustrates a process for a segment labeling sequence.

FIG. 5 illustrates a percentage of points above neighbor difference (minimum segment size=500).

FIG. 6 illustrates a percentage of points above neighbor difference (minimum segment size=180).

FIG. 7 illustrates an embodiment of a segmented image after region growing.

FIG. 8 illustrates a small segments boundary check for merging.

FIG. 9 illustrates an embodiment of a segmented image after merging of small segments.

FIG. 10 illustrates a sample image.

FIG. 11 illustrates an overlay of two human segmentations.

FIG. 12 illustrates matching the reference with the proposed segmentation.

FIG. 13 illustrates segmentation result for the image in FIG. 10.

FIG. 14 illustrates an embodiment of F-measure between human and machine segmentation pairs.

FIG. 15 illustrates a sample image.

FIG. 16 illustrates a segmentation result for the image in FIG. 11.

FIG. 17 illustrates F-measure between human and machine segmentation pairs.

FIG. 18 illustrates a sample image.

FIG. 19 illustrates a segmentation result for the image in FIG. 14.

FIG. 20 illustrates a sample image.

FIG. 21 illustrates a segmentation result for the image in FIG. 16.

FIG. 22 illustrates a segmentation result for a high-resolution satellite image.

FIG. 23 illustrates a segmentation result for an aerial image using embodiments of the described methods.

FIG. 24 illustrates an aerial ortho-photo for a test scene.

FIG. 25 illustrates a digital surface model for the same test scene (using LiDAR point cloud).

FIG. 26 illustrates a potential of being an edge using a LiDAR layer.

FIG. 27 illustrates a potential of being edge using an infra-red layer.

FIG. 28 illustrates a potential of being edge using the 4 layers.

FIG. 29 illustrates a potential of being edge using 4 weighted layers.

FIG. 30 illustrates a segmentation result of the test scene with equally weighted layers.

FIG. 31 illustrates a segmentation result for the test scene with high weight of LiDAR layer.

FIG. 32 illustrates an embodiment of a method for grayscale/color image segmentation.

FIG. 33A illustrates an embodiment of a method for multi-layer segmentation.

FIG. 33B illustrates an embodiment of a method for multi-layer segmentation.

FIG. 33C illustrates an embodiment of a method for multi-layer segmentation.

FIG. 33D illustrates an embodiment of a method for multi-layer segmentation.

FIG. 33E illustrates an embodiment of a method for multi-layer segmentation.

FIG. 34 illustrates an embodiment of an apparatus specially configured to perform operations for single parameter segmentation of images.

FIG. 35 illustrates an embodiment of a method for single parameter segmentation of images.

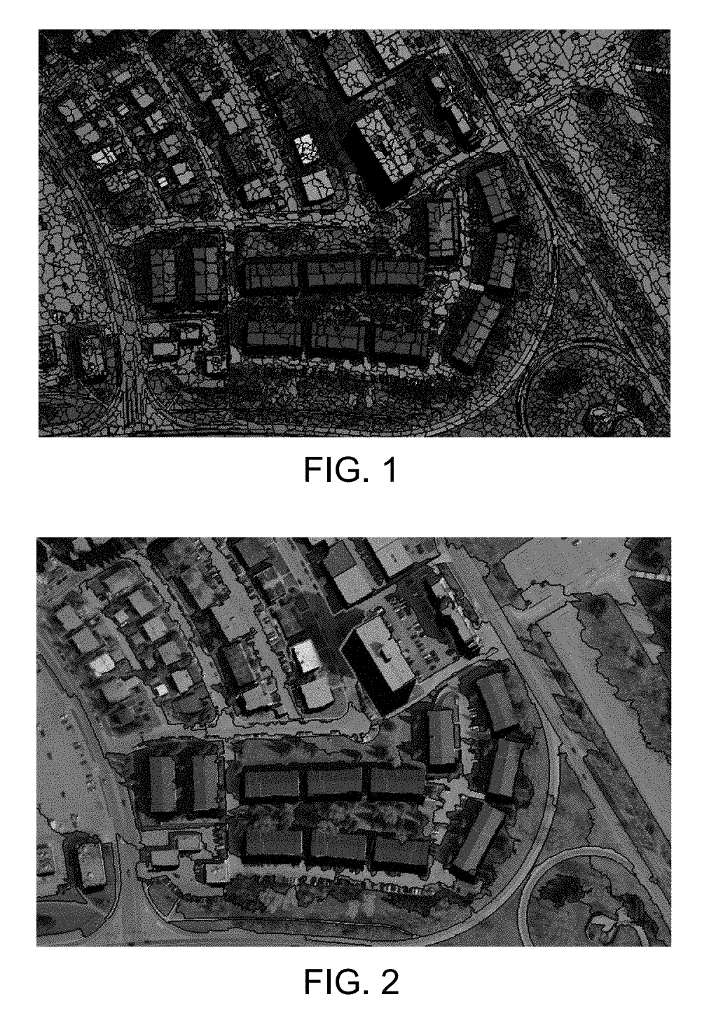

### DETAILED DESCRIPTION

Embodiments of the present methods and systems attempt to avoid both over-segmentation and under-segmentation problems by assuming preliminarily a very small object size to ensure detecting small segments and to reduce under segmentation problems. Finally, the very small segments are merged with the neighbors to reduce the over-segmentation problems.

Segmentation preprocessing step are described, and embodiments of methods for regular color image segmentation are presented with assessment results and sample segmented aerial/satellite images. Further embodiments for multi-layer image segmentation are presented with sample segmented multi-layer data set of (aerial and Light Detection And Ranging (LiDAR)) images.

Segmentation Pre-Processing

One benefit of image segmentation processes is to divide the image into distinct regions or segments where each individual region or segment is homogenous. The pixels inside each region or segment may exhibit some sort of similarity that facilitates grouping the pixels into a single segment. A high noise level exhibited within the same scene object may, however, complicate the segmentation process and induces a huge number of tiny segments especially in highly detailed aerial images. Despite the ability of the merging step of the proposed method to remove these small segments, some embodiments may include a preliminary filtering step to reduce this effect and save the time consumed by the merging step. There are several smoothing techniques that can be used to reduce the image noise. Median filtering, convolution with low pass filter kernels, and low pass filtering of the entire image are among the embodiments of techniques for image smoothing.

Bilateral smoothing filters may be used as a preliminary step because it preserves edges while smoothing the image within the regions of comparable spectral values. The bilateral smoothing filter averages the values of the neighborhood at each pixel weighted not only by their Gaussian value of their distance to the filtered pixel but also weighted by the Gaussian value of the pixels values as shown in equation 1. This added weighting helps to filter only the noise within the same spectral vicinity and therefore maintain the neighbor pixels that are far from the filtered pixel without much smoothing and hence preserve the image edges.

$${BF [ I ]}_{p} = \frac{1}{{W}_{p}} {\sum }_{q ∈ S} {G}_{{σ}_{s}} ( ‖ p - q ‖ ) {G}_{{σ}_{r}} ( \vert {I}_{p} - {I}_{q} \vert ) {I}_{q} \qquad ( 1 )$$

Where BF[I]ₚ is the bilateral filtered value at point p, Wₚ is a weighting factor, S is the neighborhood of point p, G_{σs}, G_{σr} are Gaussian functions, Iₚ, I_{q} are the image values at points p, q, and |p−q| is the distance between p, q points.

Image Segmentation

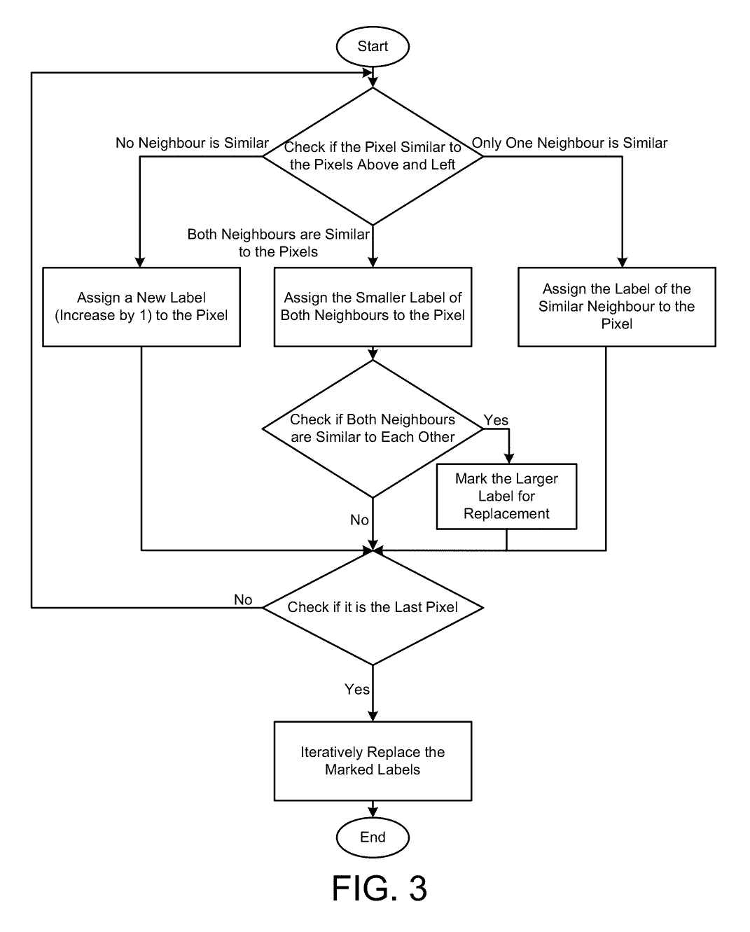

Embodiments of the segmentation method adopt both region growing and merging processes to find the suitable segments. FIG. 3 illustrates one embodiment of a segmentation method. In the depicted embodiment, a characteristic of each pixel is checked against a corresponding characteristic of neighboring pixels. If no neighboring pixels are similar, then a new label is applied to the pixel. If one neighboring pixel is similar then the label of the similar pixel is applied. If more than one neighboring pixel is similar then the smaller—in sequence—of the labels is applied and it is further determined whether both neighbors are similar to each other. If so, the larger of the labels is marked for replacement. If not, then the neighboring pixels maintain their separate labels. Next the method determines whether the last pixel in the image has been checked. If not, the process repeats for each pixel in the image. If so, then the method iteratively replaces each label marked for replacement to join smaller groups of labels with larger labels. One of ordinary skill will recognize that this process may be varied, including according to the embodiments described herein.

In an embodiment, region growing starts from any corner of image and labels each pixel into one segment. The next pixel is added to the previous label or segment if it satisfies a similarity condition. This similarity condition is based on a similarity measure and a similarity threshold based on the image statistics. Finally, the detected segments which are smaller than a predefined size are merged into lager segments. A pseudocode for the region growing process is described in Algorithm 1 below.

Algorithm 1: Region Growing Phase

Traverse the entire grid from left to right and from top to bottom.
For each pixel check the two neighbors (above and to the left) pixels for similarity
condition to determine if these pixels considered similar or not to the current pixel.
(For example, if the Euclidean distance between the L*a*b color components of
adjacent pixels is less than a threshold, these adjacent pixels considered similar).
The choice of the similarity measure and threshold values will be discussed later.
If the two neighbor pixels considered similar to the current pixel, then assign the
smaller label of the two pixels to the current pixel.
If the two neighbor pixels are considered similar to the current pixel and
considered similar to each other, then mark the larger label to be replaced with the
smaller one.
If only one neighbor pixel is considered similar to the current pixel. Assign its
label to the current pixel.
If none of the two neighbors considered similar to the current pixel, give the
current pixel a new label (largest used label +1).
After the whole grid visited, traverse the whole grid again to replace all marked
labels recursively and to count pixel count of each label/segment as its area.

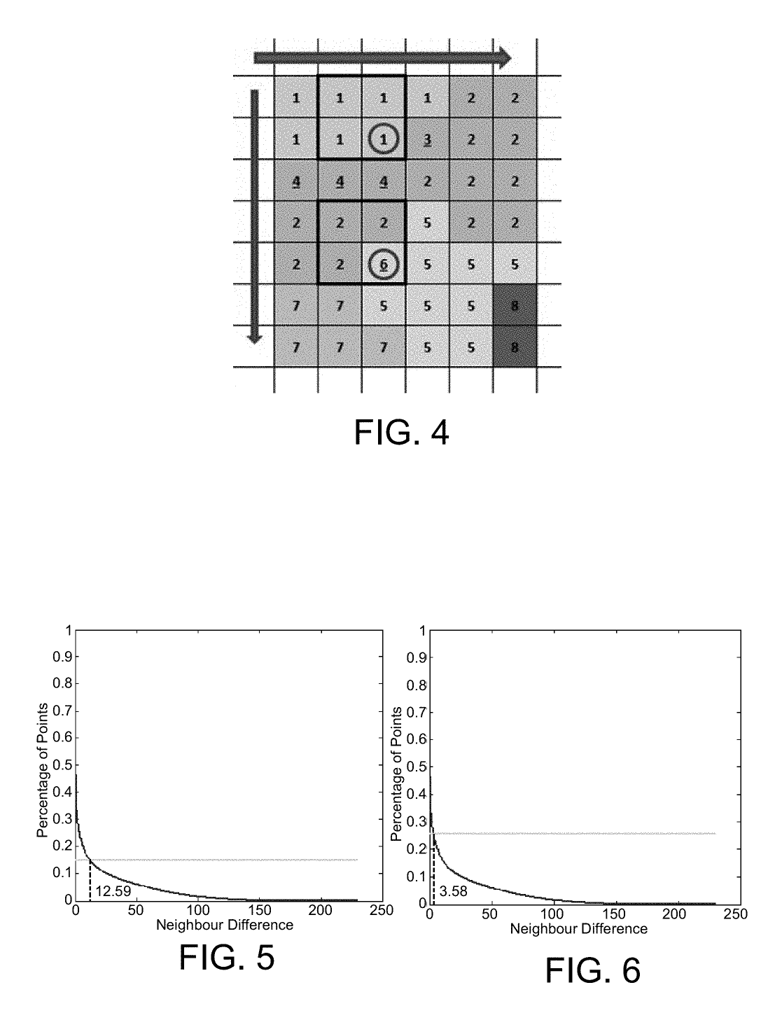

FIG. 4 illustrates the segments labeling sequence of a small sample image where the pixels of the same color are considered similar for illustration. In an embodiment, the labeling starts from top row to the bottom and from the left column to the right. The two circled pixels give two examples of the region growing sequence. The first circled pixel labeled with number 1 was checked against its two neighbor (above and to the left) pixels and since it is similar to both of those pixels (e.g., same color), it may be assigned the same label number 1. The second circled pixel numbered 6 may be checked against its neighbors and found to be different than both pixels. Therefore, the second circled pixel may be assigned a new label number 6, which is the next label after the largest previously assigned label 5. This new label may be marked for replacement by label 5 when the next pixel is visited. The next pixel has two similar neighbors with different labels, so the larger label number 6 is marked for replacement by the smaller one number 5.

In an embodiment, the similarity measure to be used may be dependent on the available data. The difference of the intensity of gray scale images may be used also as the similarity measure. Additionally, any derived measures based on the neighborhood of the pixels can be used. For color images, a measure that reflects the perception difference uniformly between colors could be used. For example, the Euclidean distance between the L*a*b* color space components of each pixel is a good candidate similarity measure, as it alleviates the non-uniformity of the distances in the RGB color space.

Similarity checks between neighbor pixels compare the chosen similar measure against a threshold to determine if these pixels are similar or not. The choice of such threshold is very crucial for achieving proper data segmentation.

Choosing a large threshold will always fulfill the similarity condition and will deal with regions of different nature as one segment which leads to under segmentation. On the other hand, choosing a small threshold will rarely fulfill the similarity condition and hence will lead to huge number of segments which leads to over segmentation. Both situations may be avoided through proper selection of the similarity threshold.

Most of the segmentation algorithms are highly dependent on the selection of many parameters or thresholds that affect its performance drastically. In some embodiments, several segmentation trials are performed until a satisfactory result is attained (Zhang and Maxwell 2006). The problem is more noticeable for those algorithms that depend on a large number of parameters that exhibit huge number of combinations, especially when the parameters cannot be related to the data characteristics and/or the desired result characteristics.

Contrastingly, the present embodiments use one segmentation parameter that can be chosen by the user. This parameter is the smallest expected segment size. This parameter can be decided by the user without too much effort based on the data specifications and the target level of details. Assuming that the whole image is composed of segments of the smallest size, the ratio of the edge pixels between segments to the whole number of pixels could be roughly estimated. This rough estimation of the edge pixels ratio can be used to find the similarity threshold on which this ratio of edge pixels occurs based on the histogram of similarity measure over the whole image.

To clarify the estimation of the ratio of the edge pixels to the whole image pixels, the image is assumed to be divided into rectangle segments of equal area (S) with height (α), width (α·r) and (r) is the width to height ratio.

The ratio of the edge pixels count to the image pixels count can be approximated by the ratio between the sum of the rectangle dimensions and the area of a single rectangle as given by the following equation

$$edge pixels ratio ≅ \frac{α + α \cdot r}{S} = \frac{α \cdot ( 1 + r )}{{α}^{2} \cdot r} = \frac{( 1 + r )}{\sqrt{S} \cdot \sqrt{r}} \qquad ( 2 )$$

High values for (r) increases the value of the edge pixels ratio. A default value of (r=10) may be assumed to account for elongated objects. This assumed value permits extraction of segments of size equal to the minimum expected segment size that have maximum axis length ten times its minimum axis length. The two assumptions used so far ensures above-average value for the edge pixels ratio which consequently results in under-average similarity threshold. These conservative assumptions have been made to ensure that even for images full of segments of minimum size, the region growing step is still able to differentiate between these segments.

The similarity between each image pixel and its neighbors may be calculated, and the percentage of pixels that have neighbor similarity larger than different similarity values are obtained.

FIG. 5 shows the percentage of points with neighbor similarity along different similarity measure values for an image. The similarity measure used is the Euclidean distance between the pixels colors in L*a*b* color space. For minimum segment size chosen to be 500, the corresponding edge ratio is illustrated as the horizontal line. This edge ratio is obtained at similarity measure value of 12.59. This value is selected as the similarity threshold during the region growing step.

FIG. 6 shows the percentage of points with neighbor similarity under different similarity measure values for the same image. The minimum segment size chosen is 180. The corresponding edge ratio is illustrated as the horizontal line. This edge ratio is obtained at similarity measure value of 3.58. This value is selected as the similarity threshold during the region growing step. Choosing this smaller segment size has resulted in smaller similarity threshold and therefore more segments have been produced compared to the previous case.

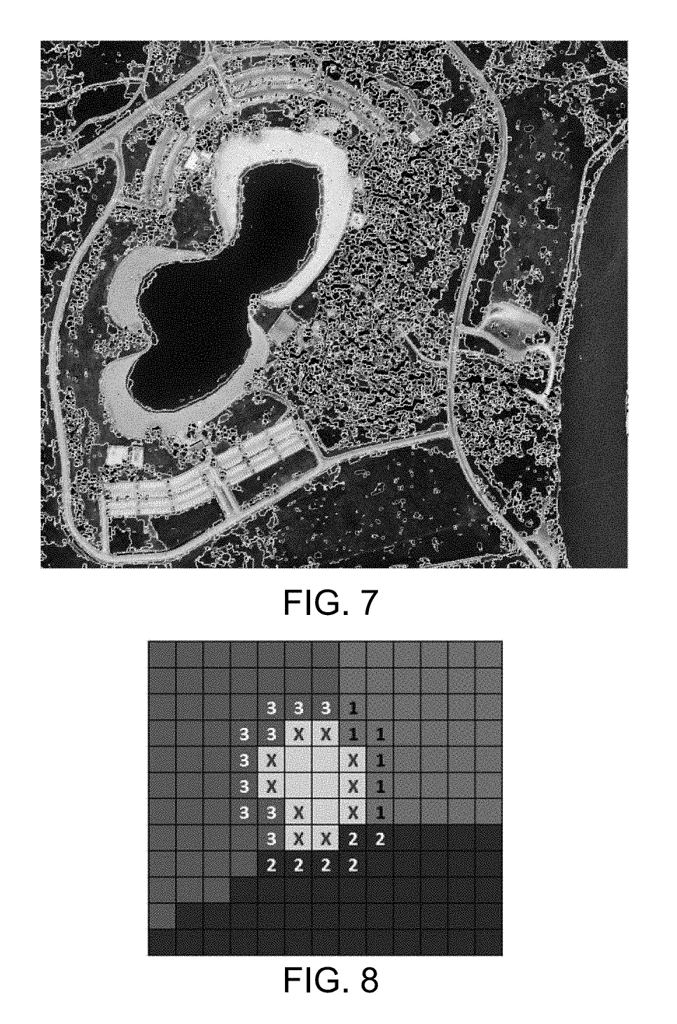

FIG. 7 illustrates the segmentation result obtained after the region growing step. Because large areas of the image are highly homogenous, these areas were segmented as large segments. The assumption that the whole image is composed of the smallest segment size, forces the similarity threshold to be small to compensate the missing edges at the homogenous areas. This leads to over segmentation of different areas across the image. This problem is handled in the final step of the proposed approach where the small segments are merged into larger neighbor segments.

As the minimum segment size parameter served to determine the similarity threshold, it is also used as the minimum accepted segment size during the final segmentation phase that merges the small segments into neighbors. A pseudocode describing one embodiment of a merging process is described in Algorithm 2 below.

Algorithm 2: Merging Phase

Calculate the mean values of all data layers of all the extracted segments.
List all the segments of size less than the minimum segment size parameter and
sort these segment ascending based on the size.
Fetch the smallest segment and track its boundary pixel by pixel using the
neighborhood of these pixels.
For each boundary pixel, find the labels of the surrounding pixel in a 3 × 3 window.
Check the similarity of the segments of the found labels with the current small
segment based on the mean values of the data layers as shown in FIG. 8.
Find the closest neighbor segment that has the minimum similarity measure with
respect to the current small segment.
Merge the current small segment into the closest segment and assign the label of
this neighbor to all the small segment pixels.
Update the data layers mean values of the merged segment based on the mean
values and sizes of the small and the closest neighbor.
Remove the small segment and its closest neighbor from the small segments list.
If the merged segment size does not exceed the minimum segment size parameter,
insert this new merged segment into the sorted list based on its size.
Repeat steps starting from the third step until the small segment list is empty.

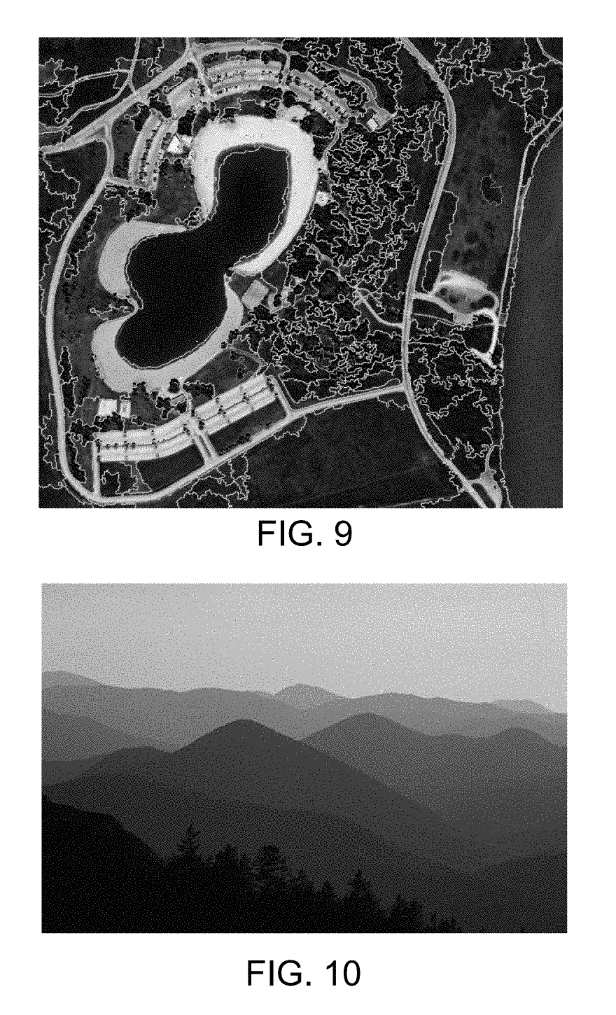

The final segmentation after merging phase is composed of segments whose areas are above the minimum segment size parameter as shown in FIG. 9

The tiny segments detected before the merging phase may be merged into their closest neighbors. The segmentation result illustrates how the presented approach targets segments of different scales at once. Large segment such as the pool in the middle of the image may be successfully extracted as a single segment while small segments representing dark green vegetation may also be successfully segmented. The segmentation process was able to separate the shore area accurately and all the roads of the scene have been extracted as very large and thin segments with accurate boundaries.

Alternatives for Similarity Measures

The purpose of the similarity measures is to define how similar two adjacent pixels are. This similarity measure can be evaluated using many alternatives.

Gradient of the image G can be used as similarity measure where high gradients indicates low spatial similarity and vice versa. The gradient may be computed as follows

G=\sqrt{Gₓ²+G_{y}²} (3)

θ=tan⁻¹(G_{y}/Gₓ) (4)

where Gₓ, G_{y} are the horizontal and vertical gradients respectively that can be computed with the help of edge detection operators such as Sobel operator. The image can be filtered before the gradient calculation to reduce the sensitivity to noise.

Difference of Gaussians (DoG) can also be used as a similarity measure in the same sense as the image gradient. It acts as a band-pass filter and could be computed as the difference between the Gaussian filtered versions of an image with different Gaussian kernel widths as follows

$$DoG = I * ( \frac{1}{2 {πσ}^{2}} {e}^{- \frac{{x}^{2} + {y}^{2}}{2 {σ}^{2}}} - \frac{1}{2 π {K}^{2} {σ}^{2}} {e}^{- \frac{{x}^{2} + {y}^{2}}{2 {K}^{2} {σ}^{2}}} ) \qquad ( 5 )$$

While the image gradient can offer good information about the image edges, it's also useful to trace the weak edges of low gradient value and boost it through the neighbor extensions of the same slope. Assuming the normalized image gradients at point p, q are (gₓₚ, g_{yp}) and (g_{xq}, g_{yq}) respectively, two measures can be calculate as follows:

slope similarity (SS)=1−∥gₓₚg_{xq}+g_{yp}g_{yq}∥ (6)

Coincidence (CS)=∥g_{yp}(y_{q}−yₚ)+gₓₚ(xₚ−x_{q})∥ (7)

The image gradient (I) are spatially filtered as follows to get the boosted similarity measure

$${BG [ I ]}_{p} = \frac{1}{{W}_{p}} {\sum }_{q ∈ N} {G}_{σ1} ( SS ) {G}_{σ2} ( CS ) {I}_{q} \qquad ( 8 )$$

This boosted gradient image (BG) can serve as a similarity measure in the same sense as the gradient image.

Assessment of the Segmentation Methods

Image segmentation is one of the main and hard problems in the computer vision field. No general automatic algorithm approaches the performance of human segmentation yet (Martin et al. 2001). While image segmentation has been an active research area for decades with too many developed algorithms, the assessment of the developed segmentation methodologies did not attract the same amount of attention. Segmentation assessment methods of different types have been developed. Supervised objective assessment and unsupervised objective assessment are examples of the main assessment categories.

In the unsupervised objective assessment, no ground truth segmentation is needed through the assessment process. Instead of using an external reference segmentation made by human subjects, empirical measures are calculated using the segmentation result itself to evaluate the quality of the extracted segments. Several qualities such as the inter-region variance, the intra-region variance, and the boundary gradient of the extracted segments are used in this unsupervised assessment.

On the other hand, supervised objective assessment uses segmentations made by human subjects as a reference to be compared with the result of the segmentation algorithm. This type of assessment offers a finer level of evaluation, and therefore are commonly used for assessment (Zhang et al. 2008). The main issue of this type of comparison is what is the perfect segmentation (Martin et al. 2001). The same scene is segmented in different ways when segmented by different human subjects. Some researchers argue that the assessment of segmentation algorithm can be done only in the context of the application task such as object recognition (Martin et al. 2001).

FIG. 10 shows a sample image from the database created by (Martin et al. 2001) for assessment purposes. The images of this database have been segmented by number (5 to 10) of human subjects.

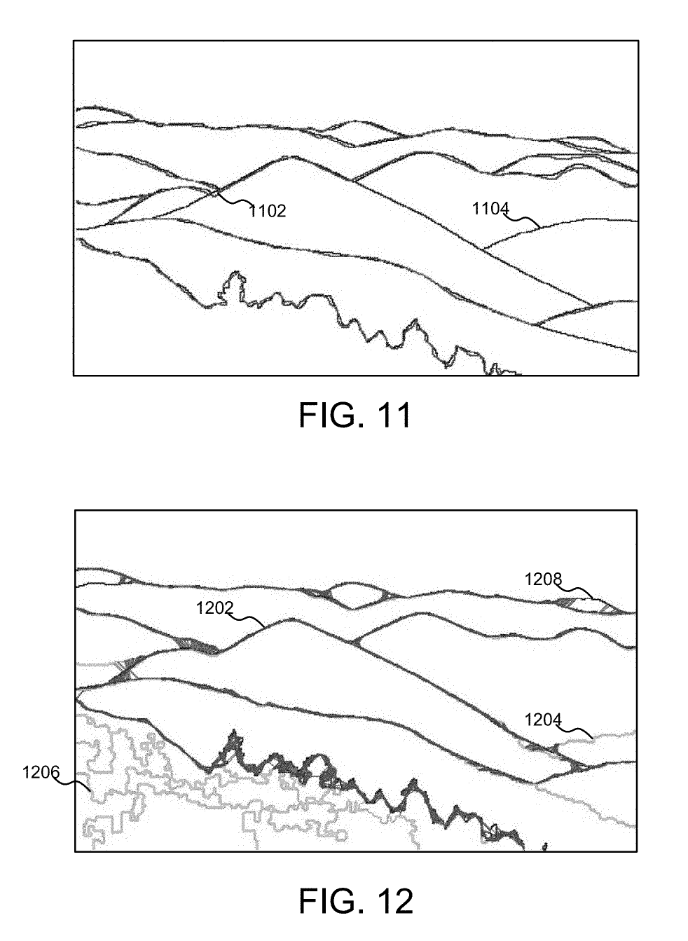

FIG. 11 illustrates two segmentations in 1102 and 1104 made by two human subjects. Some parts of the first segmentation 1102 are missed in the second segmentation 1104. Also, the two segmentations are not exactly located. A displacement of few pixels between the two segmentations is observed through the whole image.

The adopted assessment methodology uses images from the mentioned database with their human subject segmentations as a reference to be compared with the results of the proposed segmentation approach.

When the segmentation result is compared to reference segmentation, the boundaries of the two segmentations are compared in a pixel by pixel basis. Because of the expected displacement between the segmentations, the neighborhood of each reference boundary pixel is checked in the other segmentation (evaluated segmentation) within radius of a few pixels. The nearest match found is removed to prevent double mapping and the true positive (TP) count is increased by one. If no matched pixel was found in the neighborhood, the false negative (FN) is increased by one. The count of the remaining pixels in the evaluated segmentation is the false positive (FP).

A value of 7 pixels has been chosen as the accepted displacement search radius based on the observed displacements between the human subject's segmentations.

FIG. 12 shows the reference segmentation 1208, the segmentation result of the proposed approach in lines representing a first segment 1202 and a second region 1204 connects the matched pixel between them. While the matching is highly satisfactory in the mountain area (segment 1202), an over segmentation 12.6 is observed in the trees areas at the left bottom of the image.

Two main measures are derived from this matching process, namely precision and recall. The precision is a ratio that represents how much the extracted segment boundary pixel is correct and computed as follows

$$P = \frac{TP}{( TP + FP )} \qquad ( 9 )$$

The recall is a ratio that represents how much of the reference segment boundary pixels are retrieved and computed as follows

$$R = \frac{TP}{( TP + FN )} \qquad ( 10 )$$

The F-measure is the weighted harmonic mean of the precision and recall of the segmentation and is computed as follows.

$$F = ( 1 + {α}^{2} ) \frac{PR}{( R + {α}^{2} P )} \qquad ( 11 )$$

Where F is the F-measure, P is the precision, R is the recall, and a is the weighting factor.

In the cases of over-segmentation, the precision will be degraded while the recall will have the opportunity to gain more value. While in cases of under segmentation the recall will be degraded and the precision will have the opportunity to gain more value.

In the context of image classification, an over segmented image still has the opportunity to be reasonably classified. The pixel based classification can be seen as an object based classification of extremely over segmented image where the pixels itself are the segments. While, classification of under-segmented image will be significantly deteriorated as the different classes are grouped under one segment and have to be classified as either one of them. This comparison of the effect of both over-segmentation and under segmentation in the context of image classification motivates the adoption of a weighting factor that favor the over-segmentation on in other words favors the recall. For this reason a value of 2 has been chosen as a weighting factor to account for the recall twice the account for the precision.

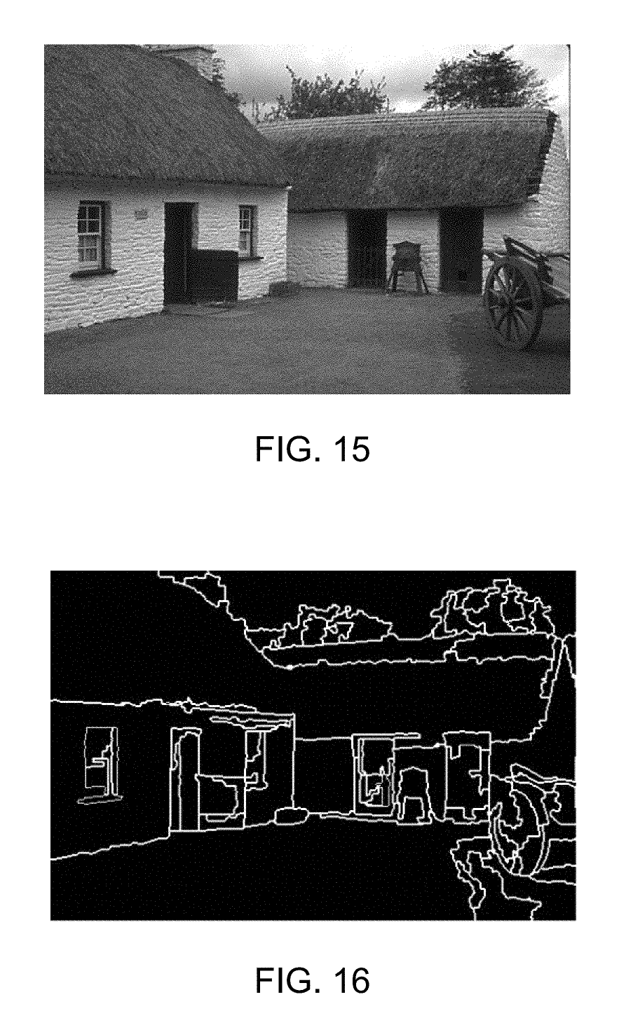

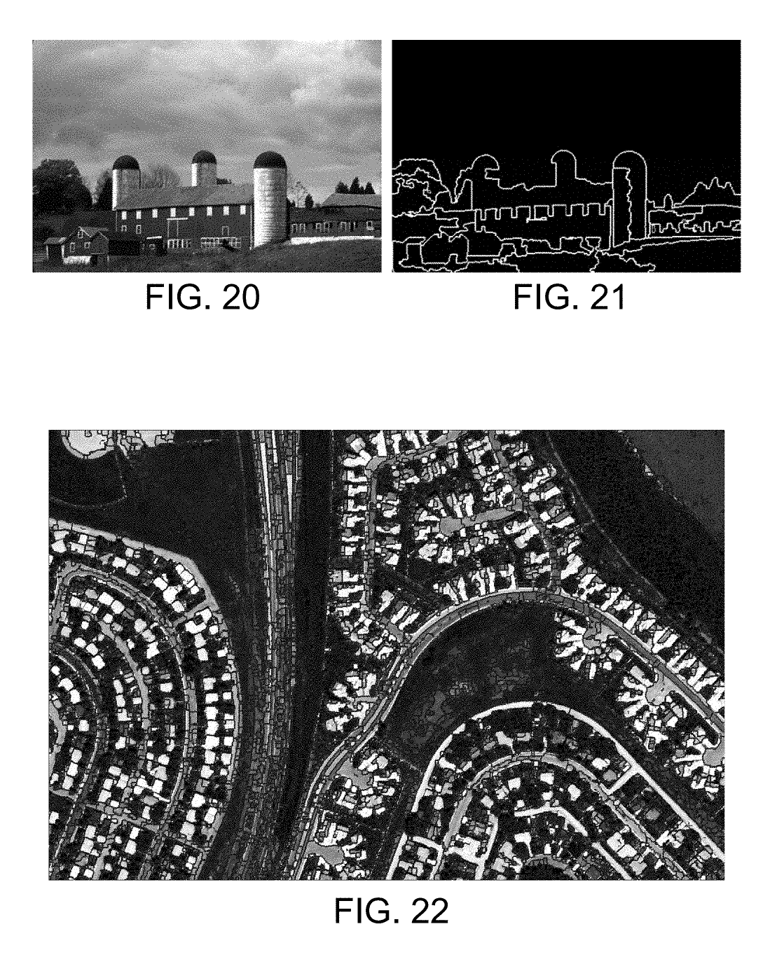

FIG. 10, FIG. 15, FIG. 18, and FIG. 20 show sample image for testing the proposed segmentation approach. Objects such as animals, vehicles, and faces are avoided in these image and only images of mountains, buildings, and trees are chosen.

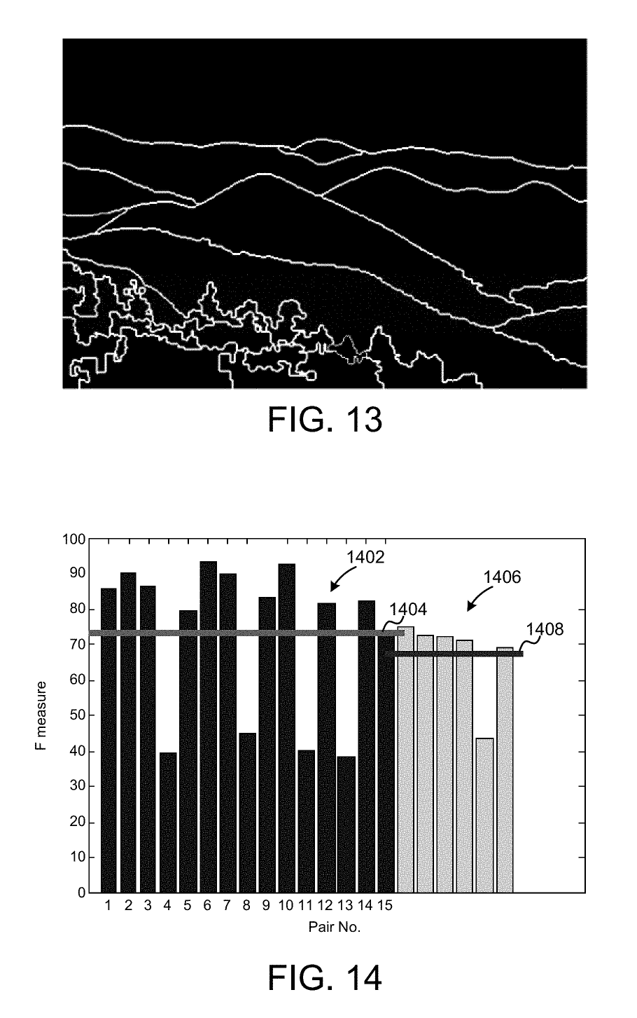

FIG. 13, FIG. 16, FIG. 19, and FIG. 21 depict the segmentation results of the proposed approach for the previous sample images.

For each test image, the assessment between the extracted segmentation and the available human segmentations is performed and also the assessment between all the pairs of the human segmentations is performed. The F-measure is computed for each assessment.

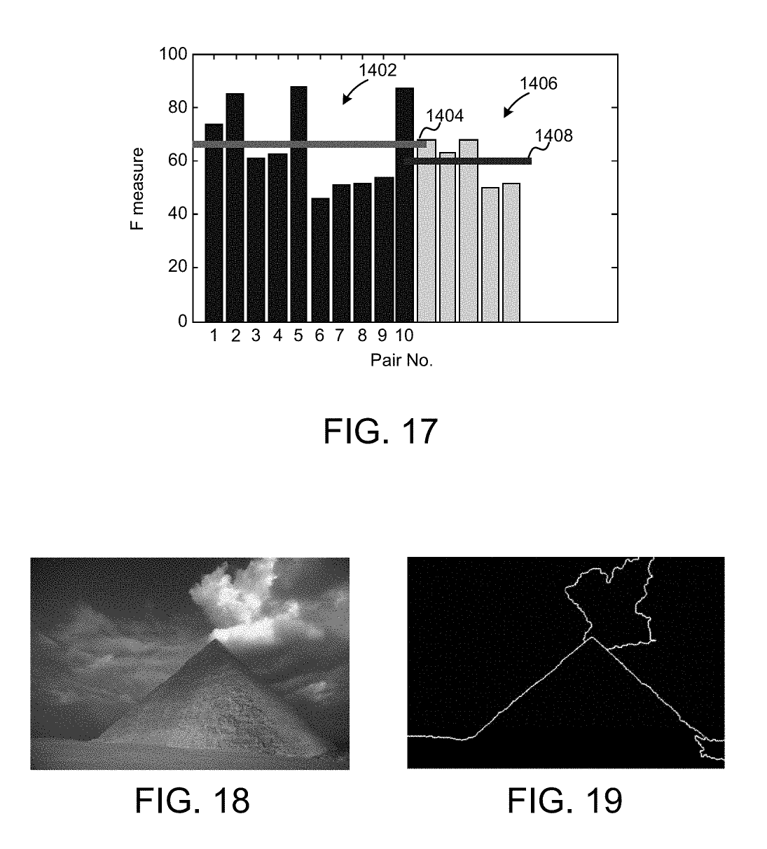

FIG. 14 and FIG. 17 show the F-measures between human assessments 1402 with its average 1404 and the F-measures for the assessments between the extracted segmentation and the human segmentation 1406 and its average 1408.

The average F-measure of the extracted segmentation is very close to the average F-measure between human segmentation which indicates excellent performance. In all the tests, some of the F-measures of the extracted segmentation exceed some of the F-measure between human segmentations. This highlights the significance of the proposed approach and also proves the variation of the reference human segmentations and the non-uniqueness of the segmentation solution.

These segmented test images show that the proposed segmentation was able to identify the relevant image segments efficiently and that the extracted segments vary in scale according to the homogeneity exhibited by the image. This behavior is compatible with the natural segmentation of human and it enables targeting of the segments of different scales concurrently. Since the Euclidean distance in L*a*b color space was used as a similarity measure through this test, the regions of slight color difference were not detected as segment edges as the case of the pyramid base line in FIG. 18. Such cases can be handled more efficiently if boosted gradient measure is included. The segmentation results did not exhibit tiny segments as the merging step ensures the minimum expected segment size is maintained. The color variation in the vegetation areas forced the proposed segmentation approach to produce small segments that has been merged to reach only the minimum expected segment size. This has left some vegetation areas slightly over-segmented. The inclusion of a texture based similarity measure can handle these situations more efficiently.

Segmentation Results of Sample Satellite/Aerial Imagery

FIG. 22 shows the segmentation results for a high-resolution satellite image for an area in Calgary city. The image is pan sharpened with ground sample distance (GSD) of 60 cm.

The distance in the L*a*b* color space was used as the similarity measure for the segmentation of this image and the minimum segment size was chosen to be very small to allow the segmentation of the individual buildings.

Despite the challenge of segmentation of satellite imagery of urban areas, the segmentation approach successfully extracted the buildings classes due to the small value of the minimum expected segment size parameter. The homogenous areas of water, barren and many of the road segments did not exhibit over segmentation. The vegetation areas exhibit over segmentation due to the high variation of its colors.

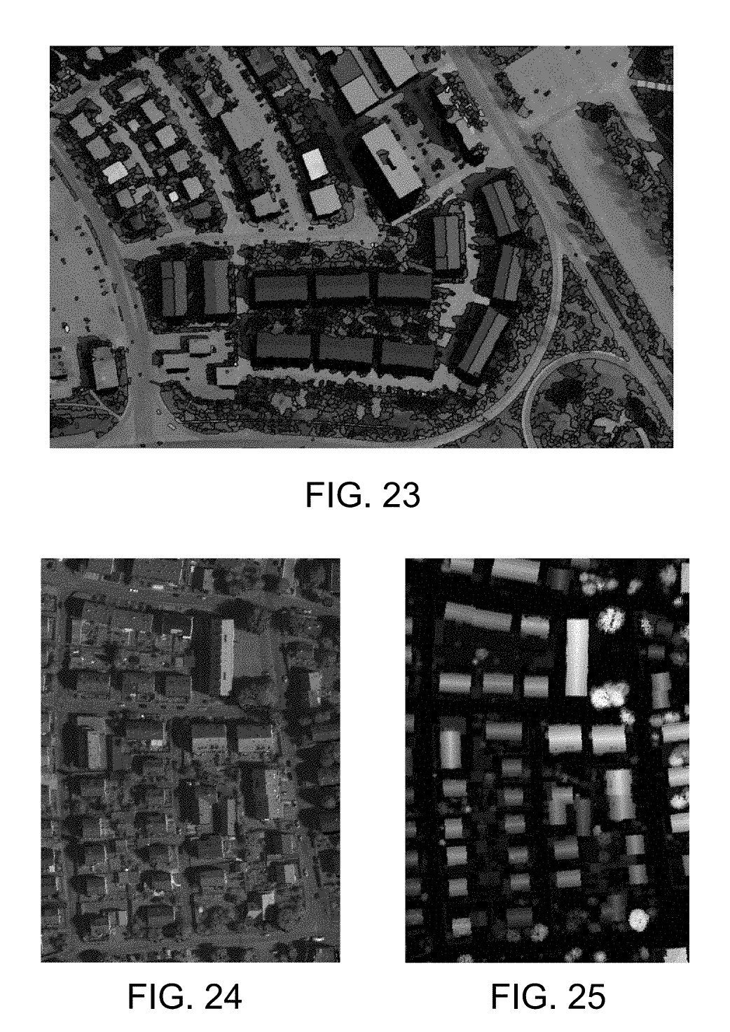

FIG. 23 depicts the segmentation results for an aerial image for an urban area in Calgary city. The image is ortho-rectified with (GSD) of 20 cm. The distance in the L*a*b* color space was used as the similarity measure for the segmentation of this image and the minimum segment size was chosen to be very small to assess the possibility of segmentation of tiny objects. This small minimum segment size parameter allowed the segmentation of the tiny vehicles in the scene successfully. The roads have been successfully segmented into very large segments despite its irregular non compact shape with many branches. Most of the buildings have been also successfully segmented. Most of the small segments belong to either vegetation or vehicles.

Collaborative Segmentation of Multiple Data layers

The continuous advancement in earth observing satellites, aerial imagery and LiDAR systems provides more and more data of different specifications and from different sensors. The same scene can be captured using these different sensors to cover different aspects about it. True color imagery offers detailed and semantically rich data layer but lacks the useful information provided by infra-red imagery that can help identify vegetation and hot spots. Hyperspectral imagery can also add more spectral details about the scene. LiDAR technology offers a reliable data layer for height description that cannot be easily or reliably obtained through imagery. These different data layers for the same scene increase the opportunity for accurate analysis, classification, and planning applications. On the other hand it increases the challenge of handling these different data layers collaboratively and efficiently. The segmentation of such various data layers should make use of these layers despite their different characteristics in a collaborative fashion that does not sacrifice any of these layers and that controls the contribution of each layer based on the application.

For the proposed segmentation to handle multiple layers of different characteristics, the selected similarity measure should reflect the similarity contribution from all these layers. FIG. 24 depicts an aerial false color ortho-photo for a test scene having infra-red (IR), red, and green bands with Ground Sample Distance (GSD) of 25 cm. FIG. 25 shows a registered Digital Surface Model (DSM) for the same test scene with GSD of 25 cm. This DSM layer has been obtained using interpolation of LiDAR point cloud.

The three IR, red and green layers represent surface reflectance values while the fourth DSM layer represents surface height. A single similarity measure that can incorporate the four layers regardless of their different representations and value ranges may be used to serve in the segmentation process.

In the proposed approach a similarity measure based on the statistics of neighborhood difference of the individual layers is presented.

For each layer the difference between the data layer values of each pixel and its neighbors are aggregated in a histogram such as the previously shown histogram in FIG. 5.

The minimum segment size parameter S is used to find the edges pixel ratio E (ratio between the edge pixels count to the total number of image pixels) and the similarity threshold θ_{threshold} of this data layer. These values are the same calculated ones if only this data layer has been available for segmentation.

If the calculated similarity difference θₛ at a pixel (i,j) is higher than the threshold value θ_{threshold} this indicates that this pixel is a candidate edge. The higher similarity difference values θₛ corresponds to lower corresponding edge pixels ratio values C(i,j). The calculated similarity difference θₛ at each pixel indicates the corresponding edge pixels ratio C(i,j) (the edge pixel ratio achieved if this difference θₛ is used as threshold) through the histogram of the similarity differences.

The edges pixel ratio E and the similarity threshold θ_{threshold} of each data layer along with the histogram of the similarity differences are used to calculate the potential of every pixel on each data layer of being an edge.

This potential is calculated as the ratio between the edges pixel ratio E of this data layer to the edge pixels ratio corresponding to the difference to neighbors value θₛ at that pixel.

$${P}_{n} ( i , j ) = \frac{E}{{C}_{n} ( i , j )} \qquad ( 12 )$$

Where Pₙ is potential of being edge at pixel (i,j) at layer (n), E is edge pixels ratio according to the minimum segment size parameter, and Cn is edge pixels ratio corresponding to the difference to neighbors value at pixel (i,j) and obtained using the histogram of the similarity difference at each data layer.

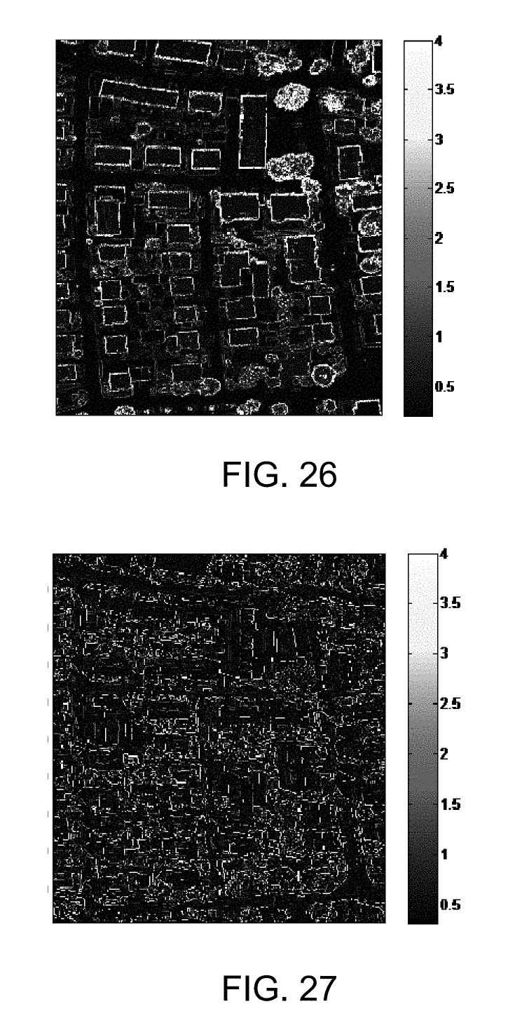

FIG. 26 shows the potential of being edge at each pixel as calculated in equation 12 based on the LiDAR data layer. The bright pixels indicate high potential of being a segment edge (high similarity difference θₛ and low corresponding edge ratio C(i,j)) while the darker ones indicate less likely pixels to be edges. According to the figure, the buildings boundary have been given high potential of being segment edges while the road pixels have been given a very small potential values.

A maximum value of 4 was permitted; all the potential values above 4 have been trimmed to 4. This trimming prevents the extremely distinct pixels of very high potential values from dominating the aggregate potential of the four layers.

FIG. 27 shows the potential of being edge at each pixel as calculated in equation 12. based on the IR data layer. The bright pixels indicate high potential of being a segment edge while the darker ones indicate pixels inside segments. According to the figure, the vegetation areas and the boundary of different light exposure areas exhibit higher potential of being segment edges. Also, a maximum value of 4 was permitted; all the potential values above 4 have been trimmed to 4.

The individual potentials of being edge at each layers have to be aggregated to form a unique representation for potential of being segment edge. As the four layers were represented in a uniform potential metric, the aggregation between these layers is simply performed by adding the potentials of the four layers.

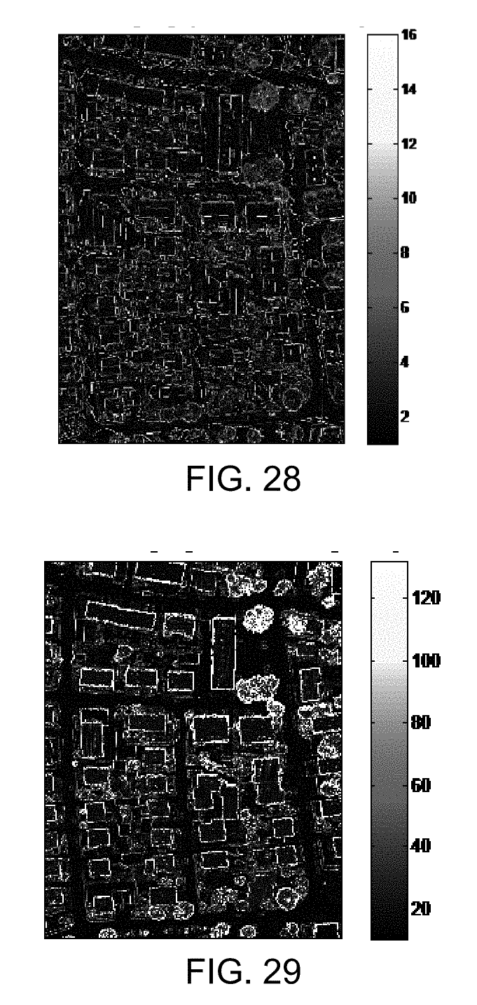

FIG. 28 shows the aggregated potential of being edge based on the four data layers. Through this aggregation each data layer has an equal opportunity to affect the choice of the segments' edges.

In some segmentation tasks, more emphasis is made on specific objects. For example, when segmentation of vegetation vs. non-vegetation is the main purpose, the IR data layer is more useful and relevant in performing the segmentation process. For such cases when some data layers have been found more useful or relevant to the segmentation, the aggregate potential map can be calculated as a weighted sum of the individual potential maps.

FIG. 29 depicts the aggregated weighted potential map of the four data layers with the LiDAR data layer weighted 30 times higher than the other data layers.

Aggregated Potential Map=30·PM_{LIDAR}+PM_{IR}+PM_{R}+PM_{G} (13)

Where PM_{LIDAR} is the potential map of the Lidar data layer, PM_{IR} is the potential map of the infra-red data layer, PM_{R}is the potential map of the red data layer, PM_{G} is the potential of the green data layer.

This aggregated potential map is threshold to find the potential threshold value corresponding to the edge ratio using a histogram. Beside the mentioned potential maps, three other potential maps are created in the same fashion to represent the potential based on vertical differences, horizontal differences and diagonal differences. These three potential maps serve as similarity measures between vertical, horizontal and diagonal adjacent pixels during the region growing phase.

The region growing phase continues in the same fashion presented before but using the potential maps instead of the direct similarity measure as follows:

Algorithm 3: Region Growing Phase (Multi-Layer)

Traverse the entire grid from left to right and from top to bottom.
For each pixel check the aggregated potential map to determine if this pixel may
be on segment edge or not.
If potential of being edge is under the potential threshold, then check the potential
map of the vertical difference and the potential map of the horizontal difference
and assign the smaller label of the two pixels to the current pixel if both potentials
are under the potential threshold.
If the diagonal potential map value is under the potential threshold then mark the
larger label to be replaced with the smaller one.
If only one potential map value either vertical or horizontal is under the potential
threshold then assign its label to the current pixel.
If none of the two vertical and horizontal potential map values is under the
potential threshold, give the current pixel a new label (largest used label +1).
After the whole grid visited, traverse the whole grid again to replace all marked
labels recursively and to count pixel count of each label/segment as its area.

Similarly, the merging phase is updated to use the potential maps instead of the similarity measure as follows:

Algorithm 4: Merging Phase (Multi-Layer)

Calculate the mean values of all data layers of all the extracted segments.
List all the segments of size less than the minimum segment size parameter and
sort these segment ascending based on the size.
Fetch the smallest segment and track its boundary pixel by pixel using the
neighborhood of these pixels.
For each boundary pixel, find the labels of the surrounding pixel in a 3 × 3 window.
Check the similarity of the segments of the found labels with the current small
segment based on the mean values of the data layers.
Find the potential value of being edge using the difference between the current
small segment mean values and each neighbor segment mean value. These
potentials are obtained through the differenced histograms of each data layer.
Find the closest neighbor segment that has the minimum aggregated potential
value.
Merge the current small segment into the closest segment and assign the label of
this neighbor to all the small segment pixels.
Update the data layers mean values of the merged segment based on the mean
values and sizes of the small and the closest neighbor.
Remove the small segment and its closest neighbor from the small segments list.
If the merged segment size does not exceed the minimum segment size parameter,
insert this new merged segment into the sorted list based on its size.
Repeat steps starting from the third step until the small segment list is empty.

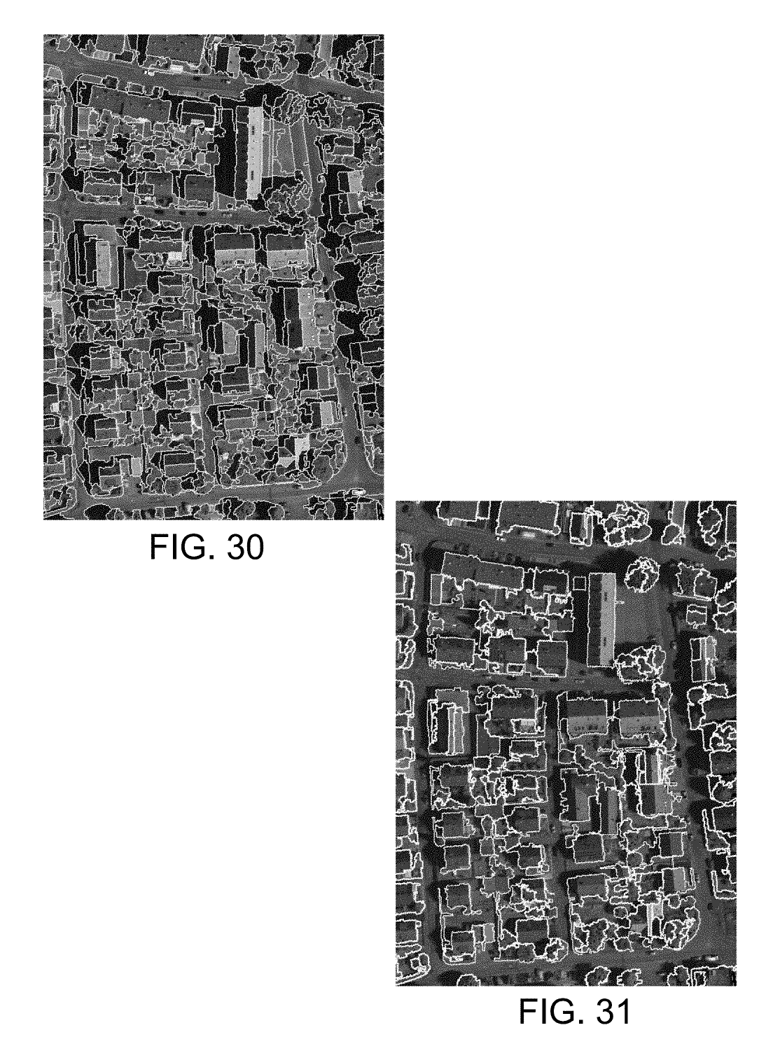

FIG. 30 shows the segmentation result of the test scene using the equally weighted four layers. Although all the road areas enjoy low potential of being segment edges based on LiDAR data layer as shown in FIG. 26, the shadowed areas of the road have been segmented because of the influence of the other data layers. The small scene objects such as the cars in the top road have not been separately segmented because of the minimum segment size constraint handled during the merging phase. FIG. 30 Segmentation result of the test scene with equally weighted layers.

FIG. 31 shows the segmentation result of the test scene using the weighted four layers. The LiDAR data layer was highly weighted more than the other three layers. Despite the color variation along the road areas, all the road areas have been segmented into one large connected segment because of the dominant influence of the LiDAR data layer as shown in FIG. 31. The gradual height change over the top of buildings decreased the potential of being edges and prevented the segments edges inside the building tops in contrary to the segmentation result where all the data layers contributed equally. Again, the small scene objects such as the cars in the top road have not been separately segmented because of the minimum segment size constraint used during the merging phase.

The following algorithms describe additional embodiments of the above processes that are particularly suited for gray scale and color image segmentation, as well as multi-layer segmentation.

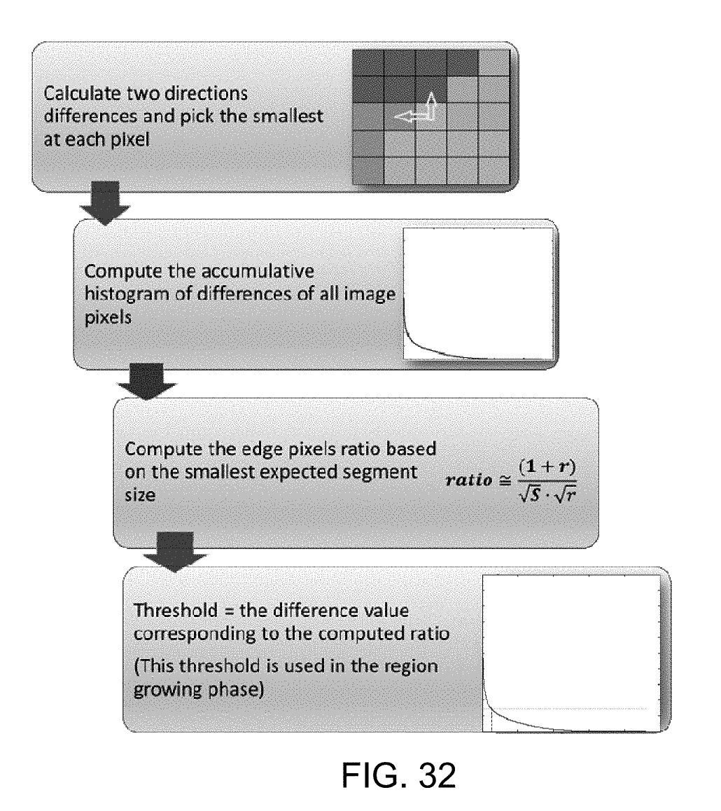

Algorithm 5 describes an embodiment method for grayscale and color image segmentation. The process of Algorithm 5 is illustrated in FIG. 32.

Algorithm 5: Grayscale/Color image segmentation

calculate two directions differences and pick the smallest at each pixel.
compute the accumulative histogram of differences of all image pixels.
compute the edge pixels ratio (E) based on the smallest expected segment
size (S) as follows
$ratio E ≅ = \frac{( 1 + r )}{\sqrt{S} \cdot \sqrt{r}}$
Where r is the largest ratio between segment dimensions (~10).
compute the similarity threshold as the difference value corresponding to
the computed ratio (E) using the computed accumulative histogram.
conduct a region growing and merging procedures using the computed
threshold according to methods described above.

Algorithm 6 describes an embodiment of a method for multi-layer segmentation.

Algorithm 6: Multi-layer segmentation

For each layer, calculate two directions differences and pick the smallest at
each pixel.
For each layer, compute the accumulative histogram of differences of all
image pixels.
For each layer, compute the edge pixels ratio (E) based on the smallest
expected segment size (S) as follows
$ratio E ≅ = \frac{( 1 + r )}{\sqrt{S} \cdot \sqrt{r}}$
Where r is the largest ratio between segment dimensions (~10).
For each pixel of each layer and using the accumulative differences
histogram, compute the edge ratio (C) corresponding to the pixel
difference value.
For each pixel of each layer, compute the pixel potential (P) to be an edge
as the ratio between (E) and (C)
${P}_{n} ( i , j ) = \frac{E}{{C}_{n} ( i , j )}$
Limit P values so it does not exceed the number of available layers.
Compute the aggregated potential image as a weighted sum of the layers
potentials.
Aggregated Potential = sum(Pᵢ · Wᵢ)
For the aggregated potential image, compute the accumulative histogram
of differences of all image pixels.
Using the last accumulative differences histogram, Compute the edge
pixels ratio based on the smallest expected segment size (S) as follows
$ratio E ≅ = \frac{( 1 + r )}{\sqrt{S} \cdot \sqrt{r}}$
Where r is the largest ratio between segment dimensions (~10).
Compute the similarity threshold as the difference value corresponding
to the computed ratio (E) using the last computed accumulative histogram.
Using this computed threshold, it conducts a region growing and merging
procedures.

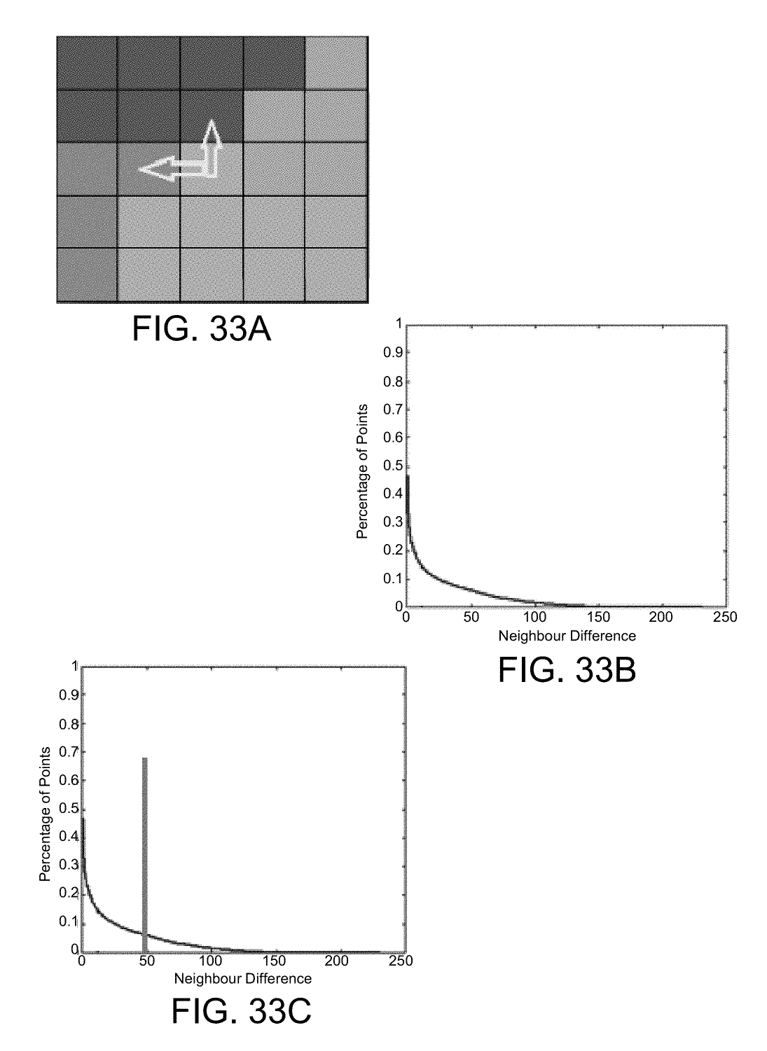

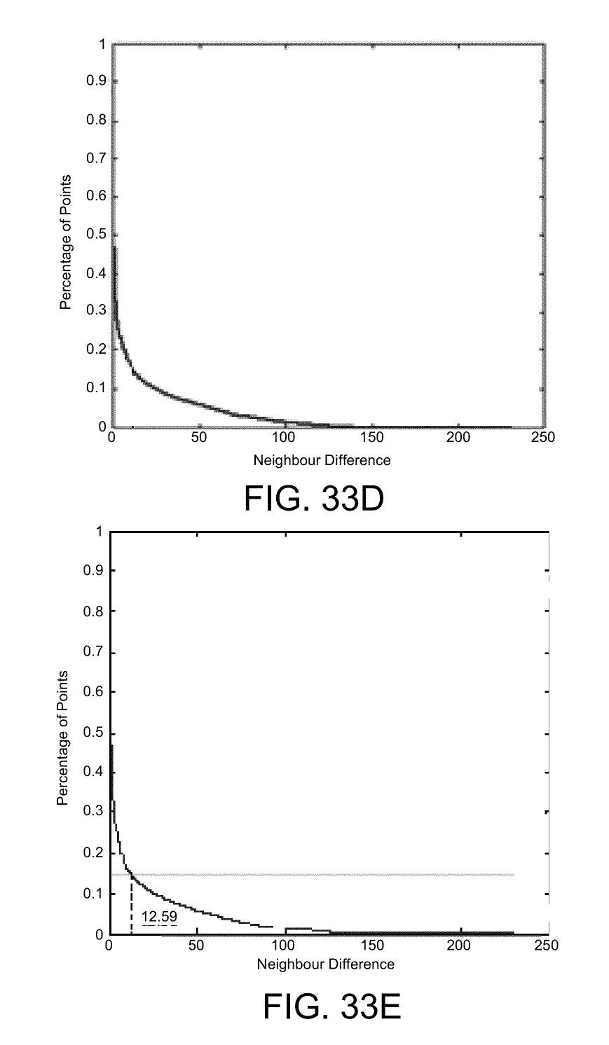

FIGS. 33A-E illustrate an embodiment of the method defined by algorithm 6. The illustrated method may proceed as follows: at FIG. 33A for each layer, calculate two directions differences and pick the smallest at each pixel; at FIG. 33B, for each layer, compute the accumulative histogram of differences of all image pixels and for each layer, compute the edge pixels ratio (E) based on the smallest expected segment size. Then, for each pixel of each layer: For each pixel of each layer:

$${P}_{n} ( i , j ) = \frac{E}{{C}_{n} ( i , j )}$$

Compute the edge ratio (C) corresponding to its difference as shown at FIG. 33C, compute the pixel potential (P) to be an edge as the ratio between (E) and (C); limit P values so it does not exceed the number of available layers; compute the aggregated potential image as a weighted sum of the layers potentials; for the aggregated potential image, compute the accumulative histogram of differences of all image pixels, and compute the edge pixels ratio based on the smallest expected segment size, as shown at FIG. 33D. In an embodiment, the threshold is the difference value corresponding to the computed ratio, (This threshold is used in the region growing phase as shown at FIG. 33E).

It may be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description may be regarded in an illustrative rather than a restrictive sense.

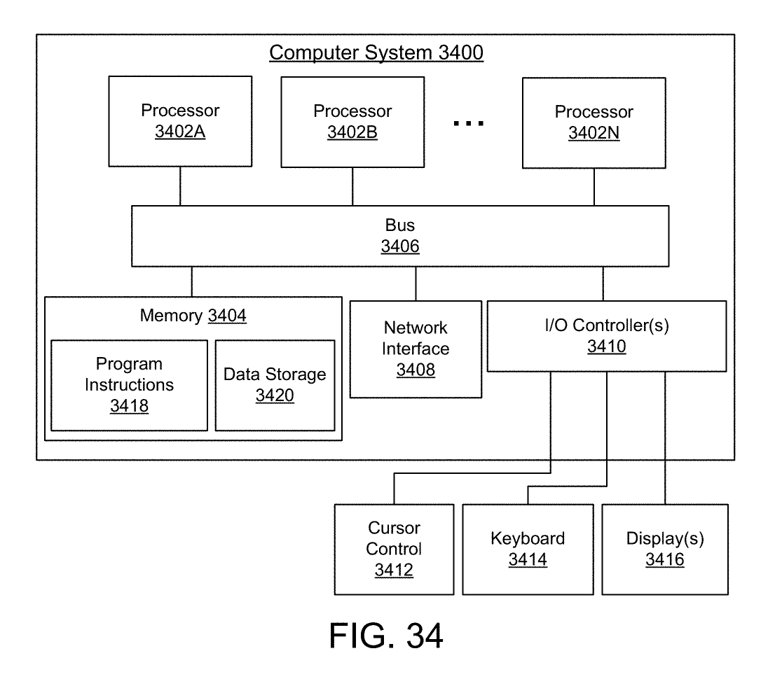

For example, FIG. 34 is a schematic block diagram illustrating one embodiment of a computer system 3400 configurable for single parameter segmentation of images. In one embodiment, Algorithms 1-6 may be implemented on a computer system similar to the computer system 3400 described in FIG. 34. Similarly, the method illustrated in FIG. 34 may be implemented on a computer system similar to the computer system 3400 described in FIG. 34. Operations described in FIGS. 3-33 may also be implemented on a computer system similar to the computer system 3400. In various embodiments, computer system 3400 may be a server, a mainframe computer system, a workstation, a network computer, a desktop computer, a laptop, or the like.

As illustrated, computer system 3400 includes one or more processors 3402A-N coupled to a system memory 3404 via bus 3406. Computer system 3400 further includes network interface 3408 coupled to bus 3406, and input/output (I/O) controller(s) 3410, coupled to devices such as cursor control device 3412, keyboard 3414, and display(s) 3416. In some embodiments, a given entity (e.g., an image processing device) may be implemented using a single instance of computer system 3400, while in other embodiments multiple such systems, or multiple nodes making up computer system 3400, may be configured to host different portions or instances of embodiments (e.g., image capture, editing, and processing devices).

In various embodiments, computer system 3400 may be a single-processor system including one processor 3402A, or a multi-processor system including two or more processors 3402A-N (e.g., two, four, eight, or another suitable number). Processor(s) 3402A-N may be any processor capable of executing program instructions. For example, in various embodiments, processor(s) 3402A-N may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processor(s) 3402A-N may commonly, but not necessarily, implement the same ISA. Also, in some embodiments, at least one processor(s) 3402A-N may be a graphics processing unit (GPU) or other dedicated graphics-rendering device.

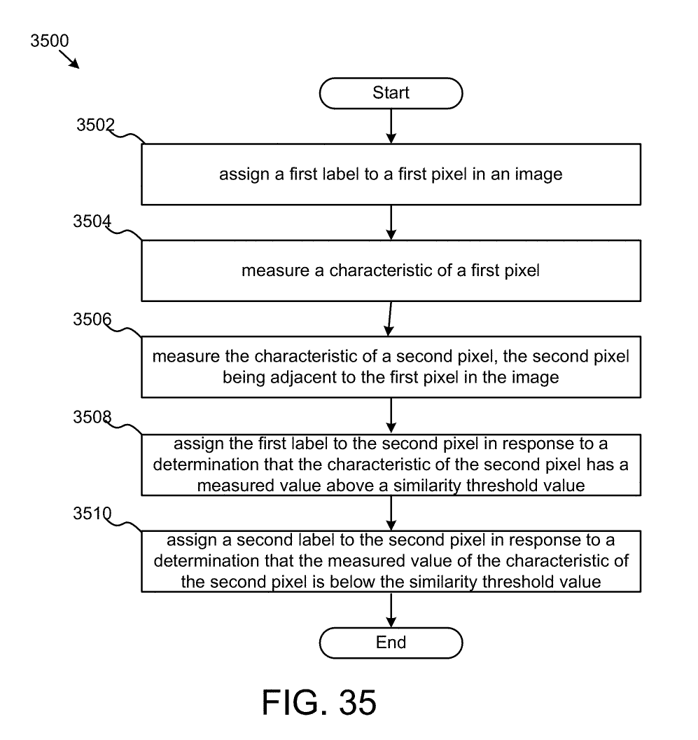

System memory 3404 may be configured to store program instructions and/or data accessible by processor(s) 3402A-N. For example, memory 3404 may be used to store software program and/or database shown in FIG. 35. In various embodiments, system memory 3404 may be implemented using any suitable memory technology, such as static random access memory (SRAM), synchronous dynamic RAM (SDRAM), nonvolatile/Flash-type memory, or any other type of memory. As illustrated, program instructions and data implementing certain operations, such as, for example, those described above, may be stored within system memory 3404 as program instructions 3418 and data storage 3420, respectively. In other embodiments, program instructions and/or data may be received, sent or stored upon different types of computer-accessible media or on similar media separate from system memory 3404 or computer system 3400. Generally speaking, a computer-accessible medium may include any tangible, non-transitory storage media or memory media such as electronic, magnetic, or optical media-e.g., disk or CD/DVD-ROM coupled to computer system 3400 via bus 3406, or non-volatile memory storage (e.g., “flash” memory)

The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, bus 3406 may be configured to coordinate I/O traffic between processor 3402, system memory 3404, and any peripheral devices including network interface 3408 or other peripheral interfaces, connected via I/O controller(s) 3410. In some embodiments, bus 3406 may perform any necessary protocol, timing or other data transformations to convert data signals from one component (e.g., system memory 3404) into a format suitable for use by another component (e.g., processor(s) 3402A-N). In some embodiments, bus 3406 may include support for devices attached through various types of peripheral buses, such as a variant of the Peripheral Component Interconnect (PCI) bus standard or the Universal Serial Bus (USB) standard, for example. In some embodiments, the operations of bus 3406 may be split into two or more separate components, such as a north bridge and a south bridge, for example. In addition, in some embodiments some or all of the operations of bus 3406, such as an interface to system memory 3404, may be incorporated directly into processor(s) 3402A-N.

Network interface 3408 may be configured to allow data to be exchanged between computer system 3400 and other devices, such as other computer systems attached to an image processing device or an image data storage device, for example. In various embodiments, network interface 3408 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

I/O controller(s) 3410 may, in some embodiments, enable connection to one or more display terminals, keyboards, keypads, touch screens, scanning devices, voice or optical recognition devices, or any other devices suitable for entering or retrieving data by one or more computer system 3400. Multiple input/output devices may be present in computer system 3400 or may be distributed on various nodes of computer system 3400. In some embodiments, similar I/O devices may be separate from computer system 3400 and may interact with computer system 3400 through a wired or wireless connection, such as over network interface 3408.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

As shown in FIG. 34, memory 3404 may include program instructions 3418, configured to implement certain embodiments described herein, and data storage 3420, comprising various data accessible by program instructions 3418. In an embodiment, program instructions 3418 may include software elements of embodiments illustrated in FIG. 35. For example, program instructions 3418 may be implemented in various embodiments using any desired programming language, scripting language, or combination of programming languages and/or scripting languages. Data storage 3420 may include data that may be used in these embodiments such as, for example, image data storage. In other embodiments, other or different software elements and data may be included.

A person of ordinary skill in the art will appreciate that computer system 3400 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be performed and/or other additional operations may be available. Accordingly, systems and methods described herein may be implemented or executed with other computer system configurations.

FIG. 35 illustrates an embodiment of a method for single parameter segmentation of images. In an embodiment, the method 3500 includes assigning a first label to a first pixel in an image as shown at block 3502. The method 3500 may also include measuring a characteristic of a first pixel (as shown at block 3504) and measuring the characteristic of a second pixel, the second pixel being adjacent to the first pixel in the image (as shown at block 3506). The method 3500 may also include assigning the first label to the second pixel in response to a determination that the characteristic of the second pixel has a measured value above a similarity threshold value as shown at block 3508, and assigning a second label to the second pixel in response to a determination that the measured value of the characteristic of the second pixel is below the similarity threshold value as shown at block 3510.

In various further embodiments, the method 3500 may include and incorporate various steps described in the pseudocode of Algorithms 1-6.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method, comprising:
assigning a first label to a first pixel in an image;
measuring a characteristic of a first pixel;
measuring the characteristic of a second pixel, the second pixel being adjacent to the first pixel in the image;
assigning the first label to the second pixel in response to a determination that the characteristic of the second pixel has a measured value above a similarity threshold value; and
assigning a second label to the second pixel in response to a determination that the measured value of the characteristic of the second pixel is below the similarity threshold value.

2. The method of claim 1, further comprising repeating the steps of claim 1 for each pixel in the image.

3. The method of claim 2, further comprising measuring a characteristic of a plurality of pixels adjacent to each pixel in the image, and assigning pixels having measured values of the characteristic over the similarity threshold to a common label.

4. The method of claim 3, further comprising assigning a lowest available label to each pixel in the image, wherein an available label is a label of one of the adjacent pixels in the image.

5. The method of claim 4, further comprising determining whether any of the plurality of adjacent pixels have measured values of the characteristic above the similarity threshold, and marking the larger label of the two for replacement.

6. The method of claim 5, further comprising iteratively replacing the marked labels.

7. The method of claim 2, further comprising measuring a characteristic of a plurality of pixels adjacent to each pixel in the image, and assigning pixels having measured values of the characteristic below the similarity threshold a different label.

8. The method of claim 1, further comprising pre-processing the image to smooth noise while keeping the transitions between features in the image.

9. The method of claim 1, wherein the measured characteristic comprises a boosted gradient of the image.

10. The method of claim 1, further comprising merging groups of pixels having a common label, where at least one of the groups has a number of pixels below a threshold pixel count value.

11. The method of claim 1, further comprising segmenting a color image.

12. The method of claim 11, wherein segmenting the color image comprises:
measuring the characteristic of a plurality of neighboring pixels adjacent the first pixel, the adjacent pixels being oriented into vertical columns and horizontal rows;
calculating differences in the values of the characteristic between pixels arranged in the horizontal row;
calculating differences in values of the characteristic between pixels arranged in the vertical column;
identifying a smallest difference in the value of the characteristic of any of the neighboring pixels.

13. The method of claim 12, further comprising computing an accumulative histogram of the differences at each pixel in the image.

14. The method of claim 13, further comprising computing an edge pixel ratio in response to a smallest expected segment size.

15. The method of claim 14, further comprising computing a similarity threshold in response to the difference value corresponding to the computed edge pixel ratio using the computed accumulative histogram.

16. The method of claim 1, further comprising segmenting multi-layer image data.

17. The method of claim 16, wherein segmenting multi-layer image data comprises:
for pixels in a first layer:
measuring the characteristic of a plurality of neighboring pixels adjacent a first pixel in the first layer, the adjacent pixels being oriented into columns and rows;
calculating differences in the values of the characteristic between pixels arranged in the row;
calculating differences in values of the characteristic between pixels arranged in the column;
identifying a smallest difference in the value of the characteristic of any of the neighboring pixels; and
for pixels in a second layer:
measuring the characteristic of a plurality of neighboring pixels adjacent a first pixel in the second layer, the adjacent pixels being oriented into columns and rows;
calculating differences in the values of the characteristic between pixels arranged in the row;
calculating differences in values of the characteristic between pixels arranged in the column;
identifying a smallest difference in the value of the characteristic of any of the neighboring pixels.

18. The method of claim 17, further comprising computing an accumulative histogram of the differences at each pixel for each layer.

19. The method of claim 18, further comprising computing an edge pixel ratio in response to a smallest expected segment size for each layer.

20. The method of claim 19, further comprising:
computing the pixel potential for each pixel of each layer;
limiting the pixel potential value such that the value does not exceed the number of available layers;
computing the aggregated potential image as a weighted sum of the pixel potential values in each layer;
computing an accumulative histogram of differences of all image pixels of the aggregated potential image.

21. The method of claim 20, further comprising computing a similarity threshold in response to the difference value corresponding to the computed edge pixel ratio using the computed accumulative histogram.

22. A system comprising:
a data storage device configured to store an image file, the image comprising a plurality of pixels; and
a data processor coupled to the data storage device, the data processor configured assign a first label to a first pixel in an image;
measure a characteristic of a first pixel;
measure the characteristic of a second pixel, the second pixel being adjacent to the first pixel in the image;
assign the first label to the second pixel in response to a determination that the characteristic of the second pixel has a measured value above a similarity threshold value; and
assign a second label to the second pixel in response to a determination that the measured value of the characteristic of the second pixel is below the similarity threshold value.
